(19) United States
(12) Patent Application Publication
(10) Pub. No.: US 2022/0243338 A1
(43) Pub. Date: Aug. 4, 2022

(54) ELECTRODE COATING

(71) Applicant: Olin Corporation, Clayton, MO (US)

(72) Inventors: David. W. Cawlfield, Clayton, MO (US); Guy Whitfield, Clayton, MO (US)

(21) Appl. No.: 17/616,410

(22) PCT Filed: Jun. 12, 2020
(86) PCT No.: PCT/US2020/037426

§ 371 Date: Dec. 3, 2021

Related U.S. Application Data
(60) Provisional application No. 62/860,496, filed on Jun. 12, 2019.

(51) Int. Cl. C23C 18/08; C23C 18/04; C23C 18/12; C25B 11/097; C25D 5/50; C25D 3/46; C25D 3/50

(52) U.S. Cl. CPC C23C 18/08; C23C 18/04; C23C 18/1216; C25D 3/50; C25D 5/50; C25D 3/46; C25B 11/097

(57) ABSTRACT

The present invention provides electrodes comprising a core substrate, and internal layer coating, and an external layer coating and processes to prepare such electrodes.

### CROSS-REFERENCE TO RELATED APPLICATIONS

This application claims the benefit of, and priority to, U.S. Provisional Patent Application No. 62/860,496 filed on Jun. 12, 2019, the contents of which is hereby expressly incorporated by reference in its entirety.

### FIELD

The present disclosure generally relates to electrodes comprising a core substrate, an internal layer coating, and an external layer coating and processes of preparing these electrodes.

### BACKGROUND

Many commercial manufacturing processes utilize electrochemistry. For example, the chlor-alkali process electrolyzes aqueous sodium chloride or potassium chloride to form valuable commodity materials, such as chlorine gas, sodium hydroxide (caustic) or potassium hydroxide, and hydrogen gas. Water is electrolyzed to produce hydrogen gas and oxygen gas. Other electrochemical processes are used to prepare a variety of commodity chemicals and intermediates for the chemical and pharmaceutical industries. Current endeavors in commercial electrochemical processes are related to reducing energy consumption, reducing manufacturing costs, and improving the efficiency and durability of the electrodes.

In electrolytic processes, direct current is employed to produce the desired product(s). An electrolyzer, which contains at least one cell, can be used in these electrolytic processes. The cells of the electrolyzer exhibit an operating voltage (potential) that consists of a minimum equilibrium voltage associated with the electrochemical potentials of the reactants at the anode and cathode. Additional voltage (potential) is required to drive the process in the forward direction, so that product is continuously produced. This additional voltage (overpotential) is the difference between a half-reaction's thermodynamically determined reduction potential and the potential at which the redox event is experimentally observed. The term “overpotential” is directly related to a cell's voltage efficiency. In an electrolytic cell the existence of overpotential implies the cell requires more energy than thermodynamically expected to drive a reaction. Some factors that contribute to this overpotential include added resistance through ionically-conductive materials and solutions, and added resistance through all conductive elements of the electrolyzer. These overpotentials are generally electrokinetic driving forces that cause electron-transfer to occur between the electrodes and the compounds in the electrolyte.

Most electrically conductive materials can serve as electrodes. Preferably, the materials used to make the electrodes resist corrosion by the electrolyte and/or the products produced. Many otherwise suitable electrode materials lack the ability to efficiently catalyze electron transfer to an electrolyte, which requires the use of additional power. And the greater the amount of additional power used, the greater the cost of performing the electrochemical process. Coatings can be applied to the electrodes to facilitate electron-transfer, and to reduce the overpotential needed in the electrolytic process. Thus, coatings help to reduce the overall operating voltage and power consumption of an electrolytic process.

While the bulk material, also referred to as a substrate, used to create an electrode must have high electronic conductivity and mechanical properties, electrocatalytic coatings are typically made from various precious materials (palladium, platinum, gold, rhodium, iridium, lanthanide metal for example) and commonly lower the electrical conductivity of the substrate. These electrode coatings require a thin film or a thin coating ranging from 0.01 microns to 10 microns. In the commercial chlor-alkali electrolysis, cathode substrates consisting of steel, copper, and/or nickel are commonly employed. These substrates are poor electrocatalysts and in uncoated form have hydrogen overpotentials typically greater than 250 my, when electrolysis is performed at the current densities of 0.5 to 10 kA/m². Surface coatings containing platinum, palladium, ruthenium, rhodium, iridium, or mixtures of these elements have been developed to reduce overpotentials. These coating materials may be in metallic form, an alloy, or may be in the form of electrically conductive oxides. Other coatings such as nickel sulfide and mixtures of manganese oxides have also been shown to have electrocatalytic properties for hydrogen evolution.

Many problems are associated with commercially practical electrode coatings. First, electrode coatings generally lack durability. These coatings may simply wear off over time due to ineffective adhesion to the substrate or the coating may be affected by chemical or electrochemical corrosion. Second, iron poisoning can be a problem. Iron, commonly contained in the catholyte, may deposit on top of the coating, thereby reducing the cathode's efficiency. Another problem with cathode coatings occurs when an electrolyzer is turned off. Chlorine, produced at the anode, does not immediately leave the electrolyzer and can diffuse through the membrane, which is used to separate the compartments of the cell, to the cathode. Once reaching the cathode coating, chlorine (a strong oxidizing agent) will react with the cathode coating, which may be rapidly lost or deactivated.

Another problem is related to overpotential. Overpotential is logarithmically related to the current at the electrode. As overpotential increases at the electrode, the current needed to drive the process increases. The linear slope observed as overpotential increases with the logarithm of current and is known as the Tafel slope. Electrodes with or without coatings can increase or decrease the Tafel slope. A low Tafel slope is especially desirable for electrolytic processes because it enables the electrolysis process to operate at higher rates, with smaller increases in power consumption. Thus, an energy savings for the process is achieved.

Finally, another problem concerns hydrogen generation at the cathode. Hydrogen accumulates on the exterior of the cathode. Hydrogen does not conduct electricity and it blocks ions from carrying current through the electrolyte. As a result, the performance of the cathode is reduced.

Various electrode coatings containing palladium have been developed to retain hydrogen within the palladium containing layer. In these coatings, hydrogen reacts with the palladium metal to produce palladium hydride. When polarization is lost and chlorine migrates through the membrane to the cathode, the palladium hydride protects the cathode by reacting with the chlorine. This prevents or minimizes the reaction between chlorine and palladium metal, which protects the components of the cathode. The sensitivity of a cathode coating to oxidation can be measured in many ways as known in the art. One of the most efficient methods to measure this oxidation sensitivity is cyclic voltammetry.

It would be desirable to develop an electrode with improved durability, increased resistance to corrosion, reduced overpotential, and/or would not retain hydrogen gas at the surface.

### BRIEF DESCRIPTION OF FIGURES

FIG. 1 is a graphical representation of cyclic voltammetry data of the first and fifth cycles of one of the cathode samples.

FIG. 2 is a graphical representation of Tafel plots for hydrogen gas evolution, where the core substrate was not calcined and the internal layer coating was baked in air.

FIG. 3 is a graphical representation of Tafel plots for hydrogen gas evolution, where the core substrate was calcined and the internal layer coating was baked in air.

FIG. 4 is a graphical representation of Tafel plots for hydrogen gas evolution, where the core substrate was not calcined and the internal layer coating was baked in a hydrogen atmosphere.

FIG. 5 is a graphical representation of Tafel plots for hydrogen gas evolution, where the core substrate was calcined and the internal layer coating was baked in a hydrogen atmosphere.

### SUMMARY

In one aspect, disclosed herein are electrodes. In general, the electrodes comprise: (a) a core substrate, (b) an internal layer coating on the core substrate, and (c) an external layer coating on at least part of the internal layer coating. The internal layer coating (b) comprises at least one of palladium, palladium alloy, silver, silver alloy, or combinations thereof. The external layer coating (c) comprises zirconium, a zirconium alloy, zirconium oxide, ruthenium, a ruthenium alloy, ruthenium oxide, at least one lanthanide metal, at least one lanthanide alloy, at least one lanthanide oxide, at least one platinum group metal, at least one platinum group alloy, or combinations of two or more thereof.

In another aspect, disclosed herein are processes for preparing an electrode. The processes comprise (a) providing a core substrate; (b) roughening the core substrate; (c) surface cleaning the core substrate; (d) optionally calcining the core substrate; (e) applying a solution of the internal layer coating on the core substrate; (f) drying the internal layer coating solution from step (e); (g) calcining the internal layer coating from step (f); (h) repeating steps (e) through (g) multiple times; (i) applying a solution of the external layer coating at least partially on top of the internal layer coating; (j) drying the external layer solution from step (i); (k) calcining the external layer coating from step (j); and m) repeating steps (i) through (k) multiple times.

Other features and iterations of the invention are described in more detail below.

### DETAILED DESCRIPTION

One aspect of the present disclosure encompasses an electrode comprising: (a) a core substrate; (b) an internal layer coating on the core substrate wherein the internal layer coating comprises at least one of palladium, a palladium alloy, silver, a silver alloy, or combinations thereof; and (c) an external layer coating on at least in part on top of the internal layer coating, wherein the external layer coating comprises zirconium, a zirconium alloy, zirconium oxide, ruthenium, a ruthenium alloy, ruthenium oxide, at least one lanthanide metal, at least one lanthanide alloy, at least one lanthanide oxide, at least one platinum group metal, at least one platinum group alloy, or combinations of two or more thereof. These electrodes provide many beneficial attributes such as improved durability, high temperature performance, increased electrical conduction, improved corrosion resistance, and/or a reduction in hydrogen absorption in the electrode.

### (I) Electrode

The electrode comprises (a) a core substrate; an internal layer coating coated on the core substrate; and (c) an external layer coated at least in part on top of the internal layer. In general, the electrode is an electrical conductor used to make contact with an electrolyte. The electrode, as described below, may be a cathode.

(a) Core Substrate

A wide variety of core substrates may be used in the electrode. The core substrate of the electrode must have high electronic conductivity and high mechanical strength (for example, tensile strength). Generally, the core substrate comprises a metal, a metal alloy, or combinations of two or more thereof. Non-limiting examples of metal core substrates may be nickel, a nickel alloy, iron, an iron alloy, copper, a copper alloy, or combinations of two or more thereof. Non-limiting examples of suitable metal alloys for a core substrate include alumel, chromel, cupronickel, german silver, hastelloy, inconel, monel metal, mu-metal, Ni—C, nichrome, nicrosil, nisil, nitinol, nivarox, steel, stainless steel, surgical stainless steel, silicon steel, tool steel, bulat steel, chromoly, crucible steel, damascus steel, HSLA steel, high speed steel, maraging steel, Reynolds 531, wootz steel, iron, anthracite iron, cast iron, pig iron, wrought iron, fernico, elinvar, invar, kovar, spiegeleisen, ferroboron, ferrochrome, ferromagnesium, ferromanganese, ferromolybdenum, ferronickel, ferrophosphorus, ferrotitanium, ferrovanadium, ferrosilicon, arsenical copper, beryllium copper, billon, brass, calamine brass, chinese silver, dutch metal, gilding metal, muntz metal, pinchbeck, Prince's metal, tombac, bronze, aluminum bronze, arsenical bronze, bell metal, florentine bronze, glucydur, guanine, gunmetal, phosphor bronze, ormolu, gilt bronze, speculum metal, constantan, copper-tungsten, corinthian bronze, cunife, cupronickel, cymbal alloys, Devarda's alloy, electrum, hepatizon, heusler alloy, manganin, nickel silver, nordic gold, shakudo, tumbaga, or combinations of two or more thereof. In an embodiment, the core substrate comprises nickel, a nickel alloy, or combinations thereof.

(b) Internal Layer Coating

The electrode further comprises an internal layer coating. The internal layer coating is a thin coating or a thin film on the core substrate. This layer is generally made from a precious material. Precious metal, as defined herein, is a metallic element with high economic value such as ruthenium, rhodium, palladium, osmium, iridium, and platinum. Generally, the internal layer coating may be metal, a metal alloy, or combinations of two or more thereof. Non-limiting examples of metals, alloys, or combinations thereof useful for the internal layers may be palladium, a palladium alloy, silver, a silver alloy, or combinations thereof. In an embodiment, the internal layer coating comprises at least one of palladium, palladium-silver alloy, a palladium alloy, a silver alloy, or combinations of two or more thereof.

The internal coating layer may include a metal that is selected from a group that consist of, or consist essentially of palladium, a palladium-silver alloy, a palladium alloy, silver, a silver alloy, and combinations thereof. The internal coating layer may include, consist of, or consist essentially of palladium, a palladium-silver alloy, a palladium alloy, silver, a silver alloy, and combinations thereof. The internal coating layer may exclude metals other than palladium or silver. In some embodiments, the internal coating layer may not contain noble metals, precious metals, platinum group metals, or lanthanide metals, other than palladium and/or silver.

Generally, the weight % of palladium in the internal layer coating ranges from about 30% to about 99.9%. In various embodiments, the weight % of palladium in the internal later coating ranges from about 30% to about 99.9%, from about 35% to about 99%, from about 40% to about 90%, from about 45% to about 85%, or from about 50% to about 75%, or alternatively may range from about 70% to about 100%, from about 85% to about 100%, from about 90% to about 100%, or alternatively from about 95% to about 100%, or may be about 100% of the material making up the internal coating layer. The aforementioned ranges may apply to a first or sole layer of the internal coating layer, and/or all or a plurality of layers, and/or solely to the outermost layer of the internal layer coating.

Generally, the weight % of silver in the internal layer coating ranges from about 0.1% to about 70%. In various embodiments, the weight % of silver in the internal later coating ranges from about 0.1% to about 70%, from about 1% to about 65%, from about 5% to about 70%, from about 15% to about 65%, or from about 25% to about 50%.

In one preferred embodiment, the weight % of the palladium in the internal coating layer ranges from about 50% to 75% and the weight percent of the silver in the internal layer ranges from 25% to 50%.

(c) External Layer Coating

The electrode further comprises an external layer coating. The external layer coating is coated on at least portion of the internal layer coating. Generally, the external layer coating comprises precious materials. The external layer coating provides high durability and superior chemical resistance to the electrode. In general, the external layer coating comprises zirconium, a zirconium alloy, zirconium oxide, ruthenium, a ruthenium alloy, ruthenium oxide, at least one platinum group metal, at least one platinum group metal alloy, at least one platinum group oxide, at least one lanthanide metal, at least one lanthanide metal alloy, at least one lanthanide oxide, or combinations of two or more thereof. Non-limiting examples of platinum group metals may be ruthenium, rhodium, palladium, osmium, iridium, and platinum. Non-limiting examples of the at least one lanthanide metal may be yttrium, lanthanum, cerium, praseodymium, or combinations of two or more thereof.

Generally, the weight % of zirconium, a zirconium alloy, zirconium oxide, or combinations thereof in the external layer coating ranges from about 0 to about 50 weight %. In various embodiments, the weight % of zirconium, a zirconium alloy, zirconium oxide, or combinations in the external layer coating ranges from about 0% to about 50%, from about 1% to about 50%, from about 5% to about 45%, from about 15% to about 35%, or from about 20% to about 30%.

In general, the weight % of ruthenium, a ruthenium alloy, ruthenium oxide, or combinations thereof in the external layer coating ranges from about 10% to about weight 80%. In various embodiments, the weight % of ruthenium, a ruthenium alloy, ruthenium oxide, or combinations thereof in the external layer coating ranges from about 10% to about 80%, from about 30% to about 75%, from about 40% to about 70%, or from about 55% to about 65%.

In general, the weight % of the least one platinum group metal, at least one platinum group metal alloy, or combinations thereof in the external layer coating ranges from about 25% to about 95%. In various embodiments, the weight % of in the external layer coating ranges from about 25% to about 95%, from about 10% to about 90%, from about 30% to about 80%, or from about 50% to about 70%.

Generally, the weight % of the at least one lanthanide metal, at least one lanthanide metal alloy, at least one lanthanide oxide, or combinations in the external layer coating ranges from about 10 to about 70 weight %. In various embodiments, the weight % of the at least one lanthanide metal, at least one lanthanide metal alloy, at least one lanthanide oxide, or combinations in the external layer coating ranges from about 10 to about 70 weight %, from about 15 to about 55 weight %, from about 20 to about 50 weight %, or from about 30.0 to about 50.0 weight %.

In various embodiments, the external layer coating comprises about 60 wt % of the platinum group metals and 40 wt % of oxides of lanthanide group metals and oxides of zirconium.

In another embodiment, the external layer comprises about 60 wt % ruthenium and 40 wt % of oxides of cerium, yttrium, or another lanthanide metal.

In yet another embodiment, the external layer comprises about 50 wt % ruthenium, about 30 wt % zirconium, and about 20 wt % cerium.

In still another embodiment, when the external coating layer is based on platinum, the external coating layer comprises comprises 60 wt % platinum and 40 wt % cerium or 60 wt % of platinum, 20 wt % cerium, and 20 wt % zirconium.

In yet another embodiment, when the external coating layer is based on platinum, this layer may also contain palladium. In these cases, the external layer comprises 55 wt % platinum, 5 wt % palladium, and 40 wt % cerium or 55 wt % platinum, 5 wt % palladium, 20 wt % cerium, and 20 wt % zirconium.

(d) Properties of Electrode

The electrode, as described above, exhibits high durability, a high temperature performance, improved corrosion resistance, increased electrical conduction, low hydrogen overpotential, and a low Tafel slope as compared to other electrode coatings. Additionally, as compared to other electrodes, this electrode possesses a hydrophilic surface which is important, because it prevents hydrogen bubbles from accumulating on the coating surface of the electrode. As appreciated by the skilled artisan, a platinum group metal without this hydrophilic surface will absorb hydrogen through the surface, thus reducing the efficiency of the electrode.

The electrode exhibits greater durability when compared to other electrodes. Durability of the external coating layer can be measured by subjecting the electrode to at least two sweeps by cyclic voltammetry. During cyclic voltammetry, reduction occurs and causes loss of the platinum group metal from the external coating layer. In general, the loss of the at least platinum group metal from the external metal after at least two sweeps by cyclic voltammetry is less than about 70%. In various embodiments, the loss of the at least platinum group metal from the external is less than 50%, less than 45%, less than 40%, less than 35%, less than about 30%, less than about 25%, and less than about 20%.

### (II) Processes for Preparing Electrodes

In another aspect, disclosed herein, are processes for preparing the electrode. The processes comprise: (a) providing a core substrate; (b) roughening the core substrate; (c) surface cleaning the core substrate; (d) optionally calcining the core substrate; (e) applying a solution of internal layer coating to the core substrate; (f) drying the solution of the internal layer coating from step (e); (g) calcining the internal layer coating from step (f); (h) repeating steps (e) through (g) multiple times; (i) applying a solution of an external layer coating at least partially on top of the internal layer coating; (j) drying the solution of the external layer coating from step (i); (k) calcining the external layer coating from step (j); and (m) repeating steps (i) through (k) multiple times.

(a) Core Substrate

The process commences by (a) providing a core substrates. Suitable core substrates are described above in Section (I)(a).

(b) Roughening the Core Substrate

The next step in the process, step (b), comprises roughening the surface of the core substrate. As appreciated by the skilled artisan, roughening of the core substrate provides a surface that is characterized as uneven or not smooth surface. Roughening will produce grooves in the core substrate of varying depths and widths. Generally, the core substrate is contacted with an abrasive to roughen the surface. Non-limiting examples of suitable abrasives may be aluminum oxide, silicon oxide, pumice, silicate minerals, or combinations thereof. In one embodiment, the abrasive used to roughen the surface of the core substrate is corundum or aluminum oxide. After roughening the core substrate with the abrasive, the traces of abrasive remaining on the core substrate are removed by contacting the abrasive coated substrate with a gas stream, or washing the core substrate with a solvent. Non-limiting examples of suitable gases may be air, an inert gas, or combinations thereof. Non-limiting examples of suitable solvents may be water, an alcohol, or combinations thereof.

The abrasive may be of various grit sizes. Non-limiting examples of useful grit sizes may be course grit, medium grit, fine grit, very fine grit, or combinations thereof. In a preferred embodiment, the abrasive is a fine grit.

The abrasive may comprise further other materials. These other materials may be used to coat or bond the abrasive to various materials. Non-limiting examples of these other materials may be binders, resins, glues, or combinations thereof. The combination of these materials and an abrasive may be coated or affixed onto a substrate. The combination of these materials, abrasive, and the substrate may be used to roughen the surface of the core substrate. Non-limiting examples of the combinations of these materials, abrasive, and the coated substrate may be an abrasive pad, sandpaper, abrasive coated wheels, abrasive coated belts, or combinations thereof.

The abrasive may contact the core substrate in various ways. One example comprises rubbing the core substrate with an abrasive coated material (such as sandpaper). Another example comprises contacting the core substrate with an abrasive in an air jet (such as sand or grit blasting). Other methods known in the art comprise rolling mill and a roll that has a finely constructed groove patterns on the surface. The skilled artisan readily knows many other ways of roughening the surface of the core substrate.

(c) Surface Cleaning of the Core Substrate

The next step in the process comprises step (c), surface cleaning of the core substrate. Cleaning the surface of the core substrate comprises contacting the core substrate with a cleaning solution, an aqueous mineral acid, or combinations thereof. This step not only cleans the surface of the core substrate by removing excess abrasive, heavy deposits of metal oxides and impurities but also optionally etches the surface of the core substrate. As appreciated by the skilled artisan, there are a number of methods to contact the cleaning solution, an aqueous mineral acid, or combinations thereof with the core substrate. Non-limiting methods may be soaking or dipping the core substrate in the cleaning solution, an aqueous mineral acid, or combinations thereof, spraying the cleaning solution, an aqueous mineral acid, or combinations thereof onto the core substrate, coating the cleaning solution, an inorganic acid, or combinations thereof onto the core substrate, or combinations thereof. After contacting the cleaning solution, an aqueous mineral acid, or combinations thereof with the core substrate, the core substrate may be further rinsed with distilled or deionized water to remove excess cleaning solution, mineral acid, or combinations thereof.

In general, cleaning the core substrate comprises contacting the core substrate with a cleaning solution, an aqueous mineral acid, or combinations thereof. The aqueous mineral acid may be a solution of the inorganic mineral acid at various concentrations. Non-limiting examples of mineral acids may comprise sulfuric acid, phosphoric acid, nitric acid, hydrochloric acid, hydrobromic acid, hydrofluoric acid, or combinations thereof. In an embodiment, the mineral acid may be approximately 6N aqueous hydrochloric acid.

The cleaning solution comprises component that will dissolve the abrasive. In general, the cleaning solution comprises an organic acid or alternatively a strong or caustic base such as one or more alkali metal hydroxides. These acids are generally water soluble. Non-limiting examples of these organic acids may comprise acetic acid, citric acid, sulfamic acid, oxalic acid, or combinations thereof. The cleaning solution may further comprise the mono, di, or triethanolamine salts of acetic acid, citric acid, sulfamic acid, oxalic acid, or combinations thereof. Non-limiting examples of alkali metal hydroxides may comprise sodium hydroxide, potassium hydroxide, or combinations thereof.

Cleaning the core substrate typically occurs at temperatures of from about 0° C. to about 150° C. In various embodiments, the temperature of the cleaning of the core substrate may be from about 0° C. to about 150° C., from about 0° C. to about 100° C., from about 10° C. to about 75° C., from about 15° C. to about 50° C., or from about 20° C. to about 30° C. Preferably, the cleaning of the core substrate may occur at about room temperature (about ˜23° C.).

The duration for cleaning the core substrate can and will vary depending on the core substrate, cleaning solution, the aqueous mineral acid, or combinations thereof, and the temperature of the cleaning process. In general, the duration of cleaning the core substrate ranges from about 1 second to about 3 hours. In various embodiments, the duration of cleaning ranges from about 1 second to about 3 hour, from about 1 second to about 1 hour, from about 10 seconds to about 30 minutes, from about 30 seconds to about 10 minutes, from about 1 minute to about 8 minutes, or from about 4 minutes to about 7 minutes.

Generally, less than about 2 weight % of the core substrate may be removed in the steps of roughening and cleaning of the core substrate as compared to a core substrate not undergoing surface cleaning. In various embodiments, the steps of roughening and cleaning the core substrate may remove less than about 2 weight %, less than about 1.5 weight %, less than about 1.0 weight %, less than 0.5 weight %, and less than about 0.1 weight % of the core substrate.

The core substrate, after roughening and cleaning, may exhibit grooves on the core substrate of at least 1 micron to 5 microns in depth and at least 2 microns to 5 microns in width. The grooves on the core substrate may be shallower and deeper, narrower and wider, or a combination thereof.

(d) Optionally Calcining the Core Substrate

The next step in the process, step (d), is optional. In one embodiment, the surface cleaned core substrate is heated or calcined. In other embodiments, step (d), is not conducted.

This optional heating step, also referred as calcination, removes excess volatile materials and excess water from the surface of the core substrate. Additionally, this step forms a thin, electrically conductive metal oxide layer on the surface of the core substrate. This calcination step may be conducted in air, an inert gas, or combinations thereof. In an embodiment, the calcination step may be conducted in air.

Generally, optional step (d) may be performed at a temperature of at least about 500° C. In various embodiments, may be performed at a temperature of at least about 500° C., at least about 550° C., at least about 600° C., at least about 700° C., at least about 1000° C., or higher temperatures.

The duration of optional step (d) can and will vary depending on the core substrate used and the process of surface cleaning of the core substrate. Generally, the duration of this optional step (d) ranges from about 1 minute to about 24 hours. In various embodiments, the duration of step (d) ranges from about 1 minute to about 24 hours, from about 5 minutes to about 12 hours, from about 10 minutes to about 6 hours, from about 15 minutes to about one hour, or from about 20 minutes to about 40 minutes.

(e) Applying a Solution of the Internal Layer Coating to the Core Substrate

The next step in the process comprises contacting the optionally calcined core substrate from step (d), with a solution of the internal layer coating. The internal layer coating solution is applied to at least a portion of at least one surface of a core substrate. The internal layer coating solution comprises a palladium salt, a silver salt, or combinations thereof. These salts are typically dissolved in nitric acid and a non-ionic surfactant to prepare the solution. Acetic acid or ammonium hydroxide may further be optionally added to this solution.

As mentioned the internal layer coating may include palladium. Generally, the internal layer coating solution comprises from about 0.5 weight % (wt %) to 5.0 wt % of palladium. In various embodiments, the internal layer coating solution comprises from about 0.5 wt % to about 5.0 wt %, from about 0.75 wt % to about 4.0 wt %, from about 1.0 wt % to about 3.0 wt %, or from about 1.25 wt % to about 1.75 wt % of palladium.

The internal coating layer may also include silver. Generally, the internal layer coating solution comprises from about 0.0 wt % to 2.5 wt % of silver. In various embodiments, the internal layer coating solution comprises from about 0.0 wt % to about 2.5 wt %, from about 0.25 wt % to about 2.0 wt %, from about 0.5 wt % to about 1.5 wt %, or from about 0.75 wt % to about 1.25 wt % of silver

In general, numerous anions of palladium and/or silver salts may be used in the internal layer coating solution. Non-limiting examples of these anions may include acetates, acetylacetonates, alkoxides, butyrates, carbonyls, dioxides, halides, hexanoates, hydrides, mesylates, octanoates, nitrates, nitrosyl halides, nitrosyl nitrates, sulfates, sulfides, sulfonates, phosphates, or combinations of two or more thereof.

The internal layer coating solution comprises a surfactant. In some embodiments, the surfactant may be an ionic surfactant, a nonionic surfactant, a cationic surfactant, an anionic surfactant, or a zwitterionic surfactant. Non-limiting examples of surfactants may be nonionic ethoxylated and nonethoxylated surfactants, abietic acid, almond oil PEG, beeswax, butylglucoside caprate, C₁₈-C₃₆ acid glycol ester, C₉-C₁₅ alkyl phosphate, caprylic/capric triglyceride PEG-4 esters, ceteareth-7, cetyl alcohol, cetyl phosphate, corn oil PEG esters, DEA-cetyl phosphate, dextrin laurate, dilaureth-7 citrate, dimyristyl phosphate, glycereth-17 cocoate, glyceryl erucate, glyceryl laurate, hydrogenated castor oil PEG esters, isosteareth-11 carboxylic acid, lecithin, lysolecithin, nonoxynol-9, octyldodeceth-20, palm glyceride, PEG diisostearate, PEG stearamine, poloxamines, polyglyceryls, potassium linoleate, PPG's, raffinose myristate, sodium caproyl lactylate, sodium caprylate, sodium cocoate, sodium isostearate, sodium tocopheryl phosphate, steareths, TEA-C₁₂-C₁₃ pareth-3 sulfate, tri-C12-C15 pareth-6 phosphate, trideceths, or combinations thereof. In an embodiment, the surfactant is a non-ionic surfactant and comprises Triton DF12 (CAS 37281-47-3).

Generally, the internal layer coating solution comprises from about 0.01 wt % to 0.1 wt % of a surfactant. In various embodiments, the internal layer coating solution comprises from about 0.01 wt % to about 0.1 wt %, from about 0.025 wt % to about 0.075 wt %, or from about 0.04 wt % to about 0.06 wt % of a surfactant.

In general, the internal layer coating solution comprises from about 0.1 wt % to about 10.0 wt % of nitric acid. In various embodiments, the internal layer coating solution comprises from about 0.1 wt % to about 10.0 wt %, from about 0.2 wt % to about 8.0 wt %, from about 0.3 wt % to about 5.0 wt %, or from about 0.5 wt % to about 2.0 wt % of nitric acid. In an embodiment, the internal coating layer solution comprises about 1 wt % nitric acid.

In general, the internal layer coating solution optionally comprises from about 0 wt % to about 40.0 wt % of acetic acid. In various embodiments, the internal layer coating solution comprises from about 0 wt % to about 40.0 wt %, from about 10.0 wt % to about 35.0 wt %, from about 20.0 wt % to about 30.0 wt %, or from about 22.0 wt % to about 28.0 wt % of acetic acid.

Generally, the internal layer coating solution optionally comprises from about 0 wt % to about 40.0 wt % of ammonium hydroxide. In various embodiments, the internal layer coating solution comprises from about 0 wt % to about 40.0 wt %, from about 10.0 wt % to about 35.0 wt %, from about 20.0 wt % to about 30.0 wt %, or from about 22.0 wt % to about 28.0 wt % of ammonium hydroxide.

The internal layer coating solution may further comprise water. The water provides a reduction in viscosity to adequately deliver the internal layer coating solution to the optionally calcined core substrate.

The internal layer coating solution may be prepared by forming a reaction mixture comprising a palladium salt, a silver salt, a surfactant, nitric acid, optionally acetic acid, ammonium hydroxide, water, or combinations thereof. These components may be added all at the same time, sequentially, or in any order. Optionally, the surfactant may be first dissolved in nitric acid, and then added at the same time or in any order. The internal layer coating solution may be achieved by blending the above components in any known mixing equipment or reaction vessel until the mixture achieves homogeneity.

The temperature of preparing the internal layer coating solution may be from about 0° C. to about 100° C. In various embodiments, the temperature of preparing the internal layer coating solution may be from about 0° C. to about 100° C., from about 10° C. to about 75° C., from about 15° C. to about 50° C., or from about 20° C. to about 30° C. Preferably, the internal layer coating may be about room temperature (about 23° C.).

Generally, the process of preparing the internal layer coating solution may be conducted at a pressure of about atmospheric pressure (˜14.7 psi) to about 200 psi. In various embodiments, the pressure of the process of preparing the internal layer coating solution may be from about atmospheric pressure (˜14.7 psi) to about 200 psi, from about 20 psi to about 180 psi, from about 40 psi to about 160 psi, from about 80 psi to about 140 psi, or from 100 psi to about 120 psi. In an embodiment, the process may be conducted at atmospheric pressure (˜14.7 psi).

The duration for preparing the internal layer coating solution can and will vary depending on the weight % of the components, the optional components, and the temperature of the mixing. In general, the duration for preparing the internal layer coating solution ranges from about 1 minute to about 24 hour to achieve a homogenous mixture of the components in the internal layer coating solution. In various embodiments, the duration for preparing the internal layer coating solution ranges from about 1 minute to about 24 hours, from about 5 minutes to about 12 hours, from about 10 minutes to about 6 hours, from about 15 minutes to about one hour, or from about 20 minutes to about 40 minutes.

The internal coating layer solution generally stand overnight at ambient temperature and pressure to ensure the components of the internal solution remain dissolved.

Application of the internal layer coating solution may be applied to the optionally calcined core substrate through various means. For example, the internal layer coating may be applied using a drawdown bar, a roller, a knife, a paint brush, a sprayer, dipping, or other methods known to the skilled artisan. In an embodiment, the internal coating solution is applied to the core substrate material at room temperature.

In various embodiments, a single application of the internal coating layer solution is applied to the core substrate. In other embodiments, multiple applications of the internal coating solution are applied to the core substrate.

Alternative to the solution coating of (e) disclosed herein, the internal coating layer may optionally be applied to the core substrate by electroplating. Electroplating may be carried out by providing an electroplating bath. The electroplating bath may include a base bath solution which may serve to dissolve or otherwise carry the desired metals to be electroplated. The base bath solution may include for instance a lithium chloride solution acidified to adjust pH with an acid such as HCl. Other electroplating suitable bath compositions maybe be employed as well.

The metals to be electroplated may be added to the base bath solution, which include all the metals mentioned herein in (e), including palladium, silver, and combinations thereof. The metals, including palladium and/or silver, may be provided in the form of the aforementioned salts, including palladium salts and silver salts, with the same weight percentages of palladium and/or silver as mentioned above with respect to the internal layer coating solution.

The core substrate may then be dipped into the bath, which may act as a cathode in the electroplating process. As mentioned previously, the core substrate may include nickel. A counter electrode may also be provided such as an anode. The anode may be may be made up of palladium, silver and/or other metals suitable for use as an anode in an electroplating process. As a current is applied or otherwise flows between the anode and cathode, the palladium and/or silver ions electroplate onto the surface of the core substrate thereby forming the internal layer coating. The use of palladium will cause the formation of a palladium internal layer coating. Similarly, the use of silver will cause the formation of a silver layer. The use of the combination of palladium and silver in the electroplating bath will cause the formation of a palladium-silver alloy coating. This may be carried out one or more times to form a single or multiple layers.

When electroplating is employed, the drying step (f) and/or the calcining step (g) is optional.

(f) Drying the Internal Layer Coating Solution on the Core Substrate

The next step, step (f), in the process comprises drying one coat of the internal layer coating solution on the core substrate. The drying of the internal layer coating solution may be optionally dried under a dry stream of room temperature air initially. This step ensures that all the uncoated spaces on the substrate are adequately coated.

In general, the temperature for drying of one coat of the internal layer on the core substrate ranges from about 25° C. to about 150° C. For temperatures above 25° C., an oven is used. In various embodiments, the temperature for drying of the one coat of the internal layer on the core substrate ranges from about 25° C. to about 150° C., from about 40° C. to about 140° C., from about 60° C. to about 120° C., from about 80° C. to about 110° C., or from about 90° C. to about 100° C.

The duration for drying one coat of the internal layer coating solution on the core substrate can and will vary depending on the mixture of the internal layer coating solution on the core substrate. Generally, the duration of drying one coat of the internal layer coating solution on the core substrate ranges from about 1 minute to about 24 hour. In various embodiments, the duration of drying one coat of the internal layer coating solution on the core substrate ranges from about 1 minute to about 24 hour, from about 5 minutes to about 12 hours, from about 10 minutes to about 6 hours, from about 15 minutes to about one hour, or from about 20 minutes to about 40 minutes. Drying of the one coat of the internal layer coating solution on the core substrate may be conducted in air, an inert atmosphere, or combinations thereof.

(g) Calcining the Internal Layer Coating from Step (f)

The next step in the process, step (g), comprises heating the internal layer coating on the core substrate. This step, also referred to as calcination, removes excess volatile materials, organic residues, and removes water, or combinations thereof from the surface of the core substrate. This step also adheres the internal coating onto the core substrate. While not wishing to be bound by any theory, it is believed that the palladium salts, after being deposited on the surface of the core substrate undergo a chemical reaction with air where the palladium cations are converted into palladium metal, palladium oxide, or combinations thereof. When the calcination is performed in a hydrogen atmosphere, the palladium metal, palladium oxide, or combinations thereof are reduced, thereby forming palladium metal, which reacts with silver to form a palladium-silver alloy. Therefore the internal coating layer would comprise palladium metal, a palladium-silver alloy, or combinations thereof. Since the internal coating is performed from 2 to 10 times, most of the calcining steps are conducted under an air atmosphere while the final calcining step is conducted under a hydrogen atmosphere. The intermediate steps may be conducted in air, an inert atmosphere, a hydrogen atmosphere, or combinations thereof. In one embodiment, the last coating step of step (g) is conducted in an atmosphere comprising hydrogen.

Generally, step (g), is conducted in a hydrogen atmosphere comprising at least 1 wt % hydrogen. In various embodiments, step (g), is conducted in an atmosphere comprising at least 1 wt % hydrogen, more preferably 50 wt % hydrogen, and most preferably 99 wt % hydrogen where the remainder of the atmosphere is an inert atmosphere (such as argon). As appreciated by the skilled artisan, this final calcining step of the internal coating layer contains little, if any oxygen. In a preferred embodiment, no oxygen is present.

Alternately, a gas such as ammonia may be utilized. During the calcination step, the ammonia thermally decomposes to hydrogen and nitrogen.

Generally, step (g) may be performed at a temperature range from about 450° C. to about 600° C. In various embodiments, the temperature for step (g) of the one coat of the internal layer on the core substrate ranges from about 450° C. to about 600° C., from about 480° C. to about 580° C., from about 500° C. to about 550° C., or from about 520° C. to about 540° C.

The duration of step (g) can and will vary depending on the internal layer coating, the core substrate, the atmosphere used, and the temperature. Generally, the duration of step (g) ranges from about 1 minute to about 24 hours in air. In various embodiments, the duration of step (g) in air ranges from about 1 minute to about 24 hours, from about 5 minutes to about 12 hours, from about 10 minutes to about 6 hours, from about 15 minutes to about one hour, or from about 20 minutes to about 40 minutes.

In general, the duration of step (g) in a hydrogen atmosphere ranges from about 0.5 hours to about 12 hours. In various embodiments, the duration of step (g) in a hydrogen atmosphere ranges from about 0.5 hours to about 12 hours, from about 0.6 hours to about 8 hours, from about 0.7 hours to about 2 hours, from about 0.8 hours to about 1.2 hours or about one hour.

(h) Repeating Steps (e) Through (g).

In general, a multi-layer structure of the internal layer may be prepared by conducting the process steps (e) through (g) from about 2 to about 10 times. This multi-layer structure would comprise many layers of metal, an alloy, or combinations thereof on the core substrate. This multi-layer structure is achieved by calcining the internal coating layers in air and the final internal coating layer in hydrogen. In various embodiments, the process steps may be conducted from about 2 to about 10 times, from about 3 to 9 times, or from about 4 to 7 times. In an embodiment, the multi-layer structure of the internal layer coatings may be prepared by conducting the process steps (e) through (g) about 3 times.

Generally, the inner layer coating surface density after each process step (e) through step (g) ranges from about 2.0 micrograms per square centimeter to about 20.0 micrograms per square centimeter of palladium in each internal coating layer. In various embodiments, the inner layer surface density after each process step (e) through step (g) ranges from about 2.0 micrograms per square centimeter to about 20.0 micrograms per square centimeter, from about 4.0 micrograms per square centimeter to about 16.0 micrograms per square centimeter, from about 6.0 micrograms per square centimeter to about 12.0 micrograms per square centimeter, or from about 8.0 micrograms per square centimeter to about 10.0 micrograms per square centimeter of palladium in each internal coating layer.

In general, the inner layer coating surface density after all process step (e) through step (g) after conducting the process from 2 to 8 times ranges from about 2.0 micrograms per square centimeter to about 200.0 micrograms per square centimeter of palladium in each internal coating layer. In various embodiments, the inner layer surface density after all process step (e) through step (g) ranges from about 2.0 micrograms per square centimeter to about 200.0 micrograms per square centimeter, from about 5.0 micrograms per square centimeter to about 180.0 micrograms per square centimeter, from about 10.0 micrograms per square centimeter to about 150.0 micrograms per square centimeter, or from about 30.0 micrograms per square centimeter to about 100.0 micrograms per square centimeter of palladium in all internal coating layer.

Generally, the inner layer coating surface density after each process step (e) through step (g) ranges from about 2.0 micrograms per square centimeter to about 20.0 micrograms per square centimeter of silver in each internal coating layer. In various embodiments, the inner layer surface density after each process step (e) through step (g) ranges from about 2.0 micrograms per square centimeter to about 20.0 micrograms per square centimeter, from about 4.0 micrograms per square centimeter to about 16.0 micrograms per square centimeter, from about 6.0 micrograms per square centimeter to about 12.0 micrograms per square centimeter, or from about 8.0 micrograms per square centimeter to about 10.0 micrograms per square centimeter of silver in each internal coating layer.

In general, the inner layer coating surface density after all process step (e) through step (g) after conducting the process from 2 to 8 times ranges from about 2.0 micrograms per square centimeter to about 200.0 micrograms per square centimeter of silver in each internal coating layer. In various embodiments, the inner layer surface density after all process step (e) through step (g) ranges from about 2.0 micrograms per square centimeter to about 200.0 micrograms per square centimeter, from about 2.0 micrograms per square centimeter to about 150.0 micrograms per square centimeter, from about 5.0 micrograms per square centimeter to about 100.0 micrograms per square centimeter, or from about 10.0 micrograms per square centimeter to about 60.0 micrograms per square centimeter of silver in all internal coating layers.

(i) Applying a Solution of the External Layer Coating at Least Partially on Top of the Internal Layer Coating

The next step in the process comprises contacting the multi-layer structure from step (h) with a solution of an external layer coating where the external layer coating solution is applied at least partially on top of the multi-layer structure of the internal layers. The external layer solution comprises at least one zirconium salt, at least one ruthenium salt, at least one platinum group metal salt, at least one lanthanide salt, or a combination of two or more thereof. In one embodiment, the external solution comprises a platinum salt, a palladium salt, a cerium salt, a yttrium salt, or combinations thereof. These salts are dissolved in a solution of nitric acid, a non-ionic surfactant, and optionally water. Acetic acid is optionally added.

Generally, the external layer coating solution comprises from about 0 wt % to 5.0 wt % of zirconium. In various embodiments, the external layer coating solution comprises from about 0 wt % to about 5.0 wt %, from about 0.5 wt % to about 4.0 wt %, from about 1.0 wt % to about 3.0 wt %, or from about 1.25 wt % to about 2.0 wt % of the zirconium. In one preferred embodiment, the wt % of the zirconium in the external layer coating solution is about 0 wt %.

In general, the external layer coating solution comprises from about 0 wt % to 3.0 wt % of ruthenium. In various embodiments, the external layer coating solution comprises from about 0 wt % to about 2.0 wt %, from about 0.25 wt % to about 1.75 wt %, from about 0.5 wt % to about 1.5 wt %, or from about 0.75 wt % to about 1.25 wt % of ruthenium. In an embodiment, when platinum is in the external layer coating solution, ruthenium in the external coating solution layer is zero or about 0 wt %.

The external layer coating solution comprises at least one lanthanide salt. Non-limiting examples of these lanthanide salts may be at least one yttrium salt, at least one lanthanum salt, at least one cerium salt, at least one praseodymium salt, or combinations thereof.

Generally, the external layer coating solution comprises from about 0 wt % to 2.0 wt % of at least lanthanide or mixtures of two or more lanthanides. In various embodiments, the external layer coating solution comprises from about 0 wt % to about 2.0 wt %, from about 0.25 wt % to about 1.75 wt %, from about 0.5 wt % to about 1.5 wt %, or from about 0.75 wt % to about 1.25 wt % of at least lanthanide or mixtures of two or more lanthanides.

The external layer coating solution comprises at least platinum metal group salt. Non-limiting examples of platinum group metal salts may be at least one platinum salt, at least one ruthenium salt, at least one iridium salt, at least one rhodium salt, at least one silver salt, at least one palladium salt, or a combination of two or more thereof. In one embodiment, the at least platinum group metal salt is a platinum salt. In another embodiment, the at least one platinum metal group salt comprises platinum and palladium.

Generally, the external layer coating solution comprises from about 0.5 wt % to 5.0 wt % of at least platinum group metal. In various embodiments, the external layer coating solution comprises from about 0.5 wt % to about 5.0 wt %, from about 0.75 wt % to about 4.0 wt %, from about 1.0 wt % to about 3.0 wt %, or from about 1.25 wt % to about 2.0 wt % of at least platinum group metal. In one preferred embodiment, the external layer coating solution comprises about 1.5 wt % of platinum and 0.2 wt % of palladium.

In general, the anion portion of the above mentioned salts include, for example, acetates, acetylacetonates, alkoxides, butyrates, carbonyls, dioxides, halides, hexanoates, hydrides, mesylates, octanoates, nitrates, nitrosyl halides, nitrosyl nitrates, sulfates, sulfides, sulfonates, phosphates, or a combination of two or more thereof.

In an embodiment, the external coating layer comprises up to 1 wt % of cerium and 1.5 wt % of platinum. Other optional lanthanide salts may be added. In another embodiment, the external coating layer comprises 1.5 wt % platinum, 0.5 wt % cerium, and 0.5 wt % zirconium.

The external layer coating solution may comprise a surfactant. Suitable surfactants are detailed above in section (II)(e). In general, the external layer coating solution may comprise from about 0.01 wt % to about 1.0 wt %. In various embodiments, the external layer coating solution may comprise from about 0.01 wt % to about 1.0 wt %, from about 0.02 wt % to about 0.5 wt %, from about 0.03 wt % to about 0.2 wt %, or from 0.04 wt % to about 0.1 wt %.

In general, the external layer coating solution comprises from about 0.1 wt % to about 10.0 wt % of nitric acid. In various embodiments, the external layer coating solution comprises from about 0.1 wt % to about 10.0 wt %, from about 0.5 wt % to about 9 wt %, or from about 1.0 wt % to about 7.5 wt % of nitric acid.

In general, the external layer coating solution comprises from about 0 wt % to about 40.0 wt % of acetic acid. In various embodiments, the external layer coating solution comprises from about 0 wt % to about 40.0 wt %, from about 5.0 wt % to about 30.0 wt %, from about 10.0 wt % to about 25.0 wt %, or from about 15.0 wt % to about 20.0 wt % of acetic acid.

The external layer coating solution may further comprise water. The water provides an adequate means to deliver the external layer coating to the calcined internal layer-core substrate.

The external layer coating solution may be prepared by forming a reaction mixture comprising a zirconium salt, a ruthenium salt, at least one lanthanide salt, at least one platinum group metal salt, nitric acid, acetic acid, optionally water, or a combination of two or more thereof. These components may be added all at the same time, sequentially, or in any order. The external layer coating may be achieved by blending the above components in any known mixing equipment or reaction vessel until the mixture achieves homogeneity.

The temperature of the external layer coating solution may be from about 0° C. to about 100° C. In various embodiments, the temperature of preparing the external layer coating may be from about 0° C. to about 100° C., from about 10° C. to about 75° C., from about 15° C. to about 50° C., or from about 20° C. to about 30° C. Preferably, the temperature is about room temperature (˜20-23° C.).

Generally, the process of preparing the external layer coating solution may be conducted at a pressure of about atmospheric pressure (˜14.7 psi) to about 200 psi. In various embodiments, the pressure of the process of preparing the external layer coating may be from about atmospheric pressure (˜14.7 psi) to about 200 psi, from about 20 psi to about 180 psi, from about 40 psi to about 160 psi, from about 80 psi to about 140 psi, or from 100 psi to about 120 psi. In an embodiment, the process may be conducted at atmospheric pressure (˜14.7 psi).

The duration for preparing the external layer coating solution can and will vary depending on the weight % of the components, the temperature of the mixing, and the optional components. In general, the duration of preparing the external layer coating solution ranges from about 1 minute to about 24 hours. In various embodiments, the duration of preparing the external layer coating solution ranges from about 1 minute to about 24 hours, from about 5 minutes to about 12 hours, from about 10 minutes to about 6 hours, from about 15 minutes to about one hour, or from about 20 minutes to about 40 minutes.

Application of the external layer coating solution may be applied to at least partially on top of the internal layer through various means. For example, the external layer coating may be applied using a drawdown bar, a roller, a knife, a paint brush, a sprayer, dipping, or other methods known to the skilled artisan. A single application of the external layer may be conducted before drying or multiple applications may be conducted before drying.

(j) Drying the External Layer Coating Solution from Step (i)

The next step in the process comprises drying one coat of the external layer coating solution on at least partially on top of the internal layer coating. In general, the temperature for drying one coat of the external layer coating solution ranges from about 25° C. to about 150° C. At temperatures above 25° C., an oven is normally used. In various embodiments, the temperature for drying of the one coat of the external layer coating solution on the internal layer coating ranges from about 25° C. to about 150° C., from about 40° C. to about 120° C., from about 60° C. to about 100° C., or from about 70° C. to about 90° C.

The duration for drying one coat of the external layer coating solution can and will vary depending on the composition of the external layer coating solution, the internal layer coating, and the core substrate. Generally, the duration of drying one coat of the external layer coating solution on the internal layer coating ranges from about 1 minute to about 24 hours. In various embodiments, the duration of drying one coat of the external layer coating solution ranges from about 1 minute to about 24 hours, from about 5 minutes to about 12 hours, from about 10 minutes to about 6 hours, from about 15 minutes to about one hour, or from about 20 minutes to about 40 minutes. Drying of the one coat of the external layer coating solution may be conducted in air or an inert atmosphere.

(k) Calcining the External Layer Coating from Step (j)

The next step in the process, step (k), comprises heating the external layer coating from step (j). This calcination step removes excess volatile organic materials, organic residues, and removes water, alcohol, or combinations thereof from the surface. This step adheres the one coat of the external layer coating to the internal layer coating and forms a thin layer on the surface of the internal layer coating comprising metals, metal alloys, metal oxides, or combinations thereof.

In an embodiment, the calcining of the external layer coats may be conducted in air. This step produces metals, metal oxides, or combinations thereof.

Generally, step (k) may be performed at a temperature range from about 450° C. to about 550° C. In various embodiments, the temperature for step (k) of the one coat of the external layer ranges from about 450° C. to about 550° C., from about 460° C. to about 540° C., from about 470° C. to about 530° C., from about 480° C. to about 520° C., or from about 490° C. to about 510° C. Step (k) can be performed in air, hydrogen or a mixture thereof.

The duration of step (k) can and will vary depending on the external layer coating, the internal layer coating, and the core substrate. Generally, the duration of step (g) ranges from about 1 minute to about 24 hours. In various embodiments, the duration of step (k) ranges from about 1 minute to about 24 hours, from about 5 minutes to about 12 hours, from about 10 minutes to about 6 hours, from about 15 minutes to about one hour, or from about 20 minutes to about 40 minutes.

(h) Repeating Steps (i) Through (k).

In general, a multi-layer structure of the external layer can be prepared by conducting the process steps (e) through (g) from about 2 to about 8 times. In various embodiments, the process steps may be conducted from about 2 to about 8 times, from about 3 to 7 times, or from about 4 to 6 times.

Generally, the external layer coating surface density after each process step (e) through step (g) ranges from about 0.4 micrograms per square centimeter to about 20 micrograms per square centimeter of at least one of zirconium, ruthenium, at least one platinum group metal, at least one noble metal, at least one lanthanide metal, or combinations of two or more thereof. In various embodiments, the external layer coating surface density after each process step (e) through step (g) ranges from about 0.4 micrograms per square centimeter to about 20 micrograms per square centimeter, from about 1.0 micrograms per square centimeter to about 16.0 micrograms per square centimeter, from about 2.0 micrograms per square centimeter to about 12.0 micrograms per square centimeter, or from about 3.0 micrograms per square centimeter to about 10.0 micrograms per square centimeter of at least one of zirconium, ruthenium, yttrium, at least one platinum group metal, at least one noble metal, at least one lanthanide metal, or combinations of two or more thereof.

Generally, the external layer coating surface density after all process step (e) through step (h) after conducting the process from 2 to 8 times ranges from about 10 micrograms per square centimeter to about 400 micrograms per square centimeter of at least one of zirconium, ruthenium, at least one platinum group metal, at least one noble metal, at least one lanthanide, or combinations of two or more thereof. In various embodiments, the external layer coating surface density after each process step (e) through step (h) ranges from about 10 micrograms per square centimeter to about 400 micrograms per square centimeter, from about 20.0 micrograms per square centimeter to about 350.0 micrograms per square centimeter, from about 25.0 micrograms per square centimeter to about 300.0 micrograms per square centimeter, or from about 3.0 micrograms per square centimeter to about 4.0 micrograms per square centimeter of platinum.

In one embodiment, the external layer coating surface density after process steps (e) through step (g) conducted multiple times may be about 8.0 micrograms per square centimeter of at least one of zirconium, ruthenium, yttrium, at least one noble metal, at least one lanthanide metal, or combinations of two or more thereof.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

Having described the invention in detail, it will be apparent that modifications and variations are possible without departing from the scope of the invention defined in the appended claims.

### EXAMPLES

The following examples illustrate various embodiments of the invention.

### Cyclic Voltammetry

Cyclic Voltammetry was performed using a Keithly Instrumentation for Electrochemical Test Methods and Application from Tektronics. The instrument uses a three-electrode system comprising a working electrode, a counter electrode, and a reference electrode. In this system, the reference electrode utilized a Hydroflex Reference Electrode and the counter electrode was nickel mesh.

TABLE 1
Settings for the Keithly Electrochemical Lab System.

| Parameter | Setting | |
|---|---|---|
| EOC Potential | 0.944999 | V |
| Source Range | 2 | |
| Number of Vertices | 4 | |
| Vertex 1 | 0 | V |
| Vertex 2 | −0.25 | V |
| Vertex 3 | 1.45 | V |
| Vertex 4 | 0 | V |
| Source Rate | 10 | mV/sec |
| # of Cycles | 25 | |
| Current Range | 7 | A |
| Sample Internal | 101 | pts/sec |
| Nplc | 0.54 | |
| Step Size | 0.0001 | V |
| Source Delay | 0.01 | sec |

X-Ray Fluorescence Method

X-ray fluorescence was used for metal measurements on prepared electrodes. The instrument used in these measurements was a Niton XL3t GOLDD+ Model 980.

XRF (X-ray fluorescence) was used to determine the elemental composition of materials. XRF analyzers determine the chemistry of a sample by measuring the fluorescent (or secondary) X-ray emitted from a sample when it is excited by a primary X-ray source. Each of the elements present in a sample produces a set of characteristic fluorescent X-rays (“a fingerprint”) that is unique for that specific element, which is why XRF spectroscopy is an excellent technology for qualitative and quantitative analysis of material composition.

Coated electrodes were analyzed after coating of either the internal or external coating layer and after measuring oxidation tolerance to establish the amount of each element present on the coating.

This instrument was calibrated for each element using certified standards of metals deposited on pure nickel plates. These certified standards were obtained at 100, 300, and 600 micrograms per square centimeter each elements ruthenium, palladium, platinum, silver, cerium, and zirconium. The standards were obtained from Calmetrics Inc. Using these standards, a three-point calibration of the instrument was performed for each element.

When performing analysis of coated mesh cathodes, no adjustment was made for the fact that a portion of the coating on the back side of each cathode was not detectible by the XRF method. The values reported in micrograms per square centimeter only represent the metals detected referenced to a planar standard, and not the total amount of metal deposited on the cathode. When the measurements are made using XRF, the presence of one element may reduce the sensitivity of XRF measurements for other elements. This effect was proportional to the amount of each. No compensation for this sensitivity effect on deposits with mixed elements was made.

### Example 1: (MVT #2, Run 3)

A 26-mesh nickel flyscreen was prepared by blasting with a 120-grit corundum and then rinsed with deionized water. The substrate was then etched for 6 minutes in 6N HCl. This was followed again by rinsing with deionized water and then calcining at 500° C. for 20 minutes in air. A first coating solution was prepared containing 3.84 grams of palladium nitrate and 0.05 grams Triton DF12 in 96 grams of 8% nitric acid to produce a solution with 1.5% palladium content. The flyscreen was dipped, the excess was allowed to drip off, and the flyscreen was then dried at 90° C. for 20 minutes, followed by baking at 470° C. for 20-30 minutes. After cooling to ambient temperature, the process was repeated three more times. A second coating solution was prepared by dissolving 9.37 grams of ruthenium nitrosyl nitrate, 0.05 grams of Triton DF12, and 12.3 grams of a 16.4% zirconium acetate solution into 78.7 grams of an 8% nitric acid solution. The fly screen with the four base coats was dipped, dried, and baked using the same temperatures as the base coats, except that the top coats were allowed to dry for 40 minutes at 90° C., before baking. A total of 6 top coats were applied. Cyclic voltammetry testing was performed in 32% sodium hydroxide solution at 80-84° C. using a nickel counter electrode and a hydrogen reference electrode. Sweeps were performed between −0.25 volts and +1.45 volts for 25 cycles. Hydrogen overpotential and Tafel slope were measured by analysis of the cyclic voltammetry data. Ruthenium loading of the substrate was measured by X-ray fluorescence before and after the test. The results of these tests may be found in Table 2.

### Example 2: (MVT #2 Run 5)

A 26-mesh nickel flyscreen was prepared and coated in the same way as example 1, except that the first coating solution was applied twice, and the second coating solution, which contained just 1% zirconium, was applied four times. The baking temperature was 500° C. Testing on this example was conducted the same way as in Example 1. The results of these tests may be found in Table 2.

### Example 3: (MVT #2 Run 9)

A 26-mesh nickel flyscreen was prepared and coated in the same way as example 1, except that the first coating solution was applied four times, the second coating solution contained just 1% zirconium and was applied six times. The baking temperature was 500° C. Testing on this example was conducted the same way as in Example 1. The results of these tests may be found in Table 2.

### Counter Example 4: (MVT #2 Run 10)

A 26-mesh nickel fly screen was prepared and coated in the same manner as example 1, except that the first coating solution was applied 6 times, and the second coating solution contained no zirconium and was applied six times. The final baking temperature was 470° C. Testing on this example was conducted the same way as in Example 1. The results of these tests may be found in Table 2.

### Counter Example 5: (MVT #2 Run 16)

A 26-mesh nickel fly screen was prepared and coated in the same manner as example 1, except that the first coating solution was applied four times, and the second coating solution contained no zirconium and was applied four times. The final baking temperature was 500° C. Testing on this example was conducted the same way as in Example 1. The results of these tests may be found in Table 2.

### Counter Example 6: (MVT #2 Run 18)

A 26-mesh nickel fly screen was prepared and coated in the same manner as example 1, except that the first coating solution was applied four times and second coating solution contained no zirconium and was applied six times. The final baking temperature was 530° C. Testing on this example was conducted the same way as in Example 1. The results of these tests may be found in Table 2.

TABLE 2
Ruthenium oxide Coating Retained after Cyclic Voltammetry

| | Base | Top | Zr in Top | Baking | Ru | Ru | Ru |
|---|---|---|---|---|---|---|---|
| Example | Layers | Layers | Layer | Temp(° C.) | Before | After | Retained |
| E1 | 4 | 6 | 2% | 470 | 309 | 262 | 85% |
| E2 | 2 | 4 | 1% | 500 | 235 | 226 | 96% |
| E3 | 4 | 6 | 1% | 500 | 451 | 416 | 92% |
| CE4 | 6 | 6 | 0% | 470 | 361 | 173 | 48% |
| CE5 | 4 | 4 | 0% | 500 | 164 | 55 | 34% |
| CE6 | 4 | 6 | 0% | 530 | 333 | 172 | 52% |

The data above shows examples E1-E3 retained more Ru than the counter examples CE4-CE6. As the data shows, the presence of zirconium in the coating layer allows for more retention of ruthenium.

### Example 7: (MVT #1 Run 10))

A 40-mesh nickel flyscreen was prepared and coated in the same manner as example 1, except that the first coating solution was surfactant free, contained 3% palladium nitrate, and was applied twice. The baking temperature was 500° C. A second coating solution was prepared containing platinum tetraammonium nitrate (to make 2% Pt) and zirconium acetate (1% Zr). Six coats of this second solution were applied. Cyclic voltammetry testing was performed in 32% sodium hydroxide solution, at 80-84° C. using a nickel counter electrode and a hydrogen reference electrode. Sweeps were performed between −0.25 volts and +1.45 volts for 25 cycles. Hydrogen overpotential and Tafel slope were measured by analysis of the cyclic voltammetry data. Platinum loading of the substrate was measured by X-ray fluorescence before and after the test. Testing on this example was conducted the same way as in example 1. The results of these tests may be found in Table 3.

### Example 8: (MVT #1 Run 3)

A 40-mesh nickel flyscreen was prepared and coated in the same manner as example 3, but in the second coating solution, cerium nitrate was substituted for zirconium acetate. Sweeps were performed between −0.25 volts and +1.45 volts for 25 cycles. Hydrogen overpotential and Tafel slope were measured by analysis of the cyclic voltammetry data. Platinum loading of the substrate was measured by X-ray fluorescence before and after the test. Testing on this example was conducted the same way as in Example 1. The results of these tests may be found in Table 3.

TABLE 3
Platinum retained after Cyclic Voltammetry

| | Example 7 | Example 8 |
|---|---|---|
| Initial Platinum loading ug/cm² | 499 | 847 |
| Pt after cyclic voltammetry | 393 | 635 |
| Retained Pt | 79% | 75% |

The results in the above table show that the inclusion of zirconium or cerium in the topcoat enables retention of more platinum in the outer coat after oxidation.

### Example 9

An electrode was initially coated with an internal layer coating containing only palladium on a nickel flyscreen. This internal layer was then coated with an external coating containing either platinum or ruthenium. As a comparison, nickel flyscreen was coated with an internal layer that did not contain palladium. This internal layer was then coated with an external coating containing either platinum or ruthenium. As Table 4 shows, the electrodes with palladium base coats have a much lower initial hydrogen overvoltage and store significantly more hydrogen than electrodes without a palladium base-coat. The lower Tafel slope of the runs with palladium in the base coat enables these electrodes to operate at lower voltage when the current density is high, compared to runs with higher Tafel slope.

Another feature of the palladium base coat as compared to base coats not containing palladium, is that the amount of hydrogen stored decreased dramatically after exposure to 25 cycles of oxidation.

TABLE 4
Tafel Slope and Hydrogen Retention Comparing
Pd Internal Layer versus Internal Layers without Pd.

| | | H₂ | Tafel |
|---|---|---|---|
| | H₂@2 kA/m² | Discharge | Slope |
| Runs Conducted | | | |
| with Pd Basecoat | | | |
| 1 | 0.102 | 0.099 | −0.040 |
| 2 | 0.115 | 0.081 | −0.045 |
| 3 | 0.071 | 0.102 | −0.015 |
| 4 | 0.076 | 0.055 | −0.016 |
| 9 | 0.077 | 0.091 | −0.008 |
| 10 | 0.088 | 0.059 | −0.023 |
| Average | 0.088 | 0.081 | −0.024 |
| Runs Conducted | | | |
| w/o Pd Basecoat | | | |
| 5 | 0.128 | 0.020 | −0.55 |
| 6 | 0.294 | 0.005 | −0.054 |
| 7 | 0.236 | 0.006 | −0.067 |
| 8 | 0.154 | −0.004 | −0.060 |
| 11 | 0.233 | 0.005 | −0.084 |
| 12 | 0.314 | 0.005 | −0.061 |
| Average | 0.227 | 0.006 | −0.063 |

### Example 10: MVT #5

Nickel mesh with 40×40 square weave mesh and 0.06 mil wires was prepared by cutting into 3.5 inch squares. Each square was grit-blasted with 120 grit corundum (aluminum oxide) powder sufficiently to produce a mat finish, and then blown free of remaining grit. All samples were then etched with 6 N Hydrochloric Acid at 22° C. for 6 minutes, rinsed with deionized (DI water), dried and weighed again.

Nickel mesh for odd numbered runs was calcined by baking in an air atmosphere at 500° C. for 20 minutes to produce an adherent nickel oxide layer. The even numbered runs were coated, but not calcined.

A base coat (internal layer) was prepared with 1.5% palladium and 0.5% silver in a solution of 8% nitric acid and 0.05% non-ionic surfactant Triton DF12. The palladium and silver in this solution were obtained from tetraammonium palladium nitrate (3.5% palladium) from Sigma Aldrich and crystalline silver nitrate ACS reagent >99.0% from Sigma Aldrich, respectively. Three layers of base coat were applied to each sample. The base coats were dried at 90° C. for 20 minutes and baked after each coat in an air or hydrogen atmosphere at the listed temperatures in Table 5.

For the top coating layer (external layer), a solution containing platinum (1.497% platinum from diamine dinitro platinum) and cerium (1.085% cerium from cerium nitrate hexahydrate) was prepared in dilute nitric acid (1.03%) and 0.05% non-ionic surfactant Triton DF12. All top coats were dried at 90° C. for 20 minutes then baked in air at 480° C.

The temperature of the hydrogen atmosphere furnace varied from 500 to 580° C. A summary of the variables altered during the coating process are shown in the following table by run number. In Table 5, −1 means the cathode was not calcined, while the 1 means the cathode was calcined. The variable for H₂ Oven shows −1 when the electrode was baked in air, and 1 when the electrode was baked in a hydrogen atmosphere.

TABLE 5

| | | | Oven |
|---|---|---|---|
| Run # | Calcined | H₂ Oven | Temp (° C.) |
| 1 | −1 | −1 | 500 |
| 2 | 1 | −1 | 500 |
| 3 | −1 | 1 | 500 |
| 4 | 1 | 1 | 500 |
| 5 | 1 | 1 | 540 |
| 6 | −1 | 1 | 540 |
| 7 | 1 | 1 | 580 |
| 8 | −1 | 1 | 580 |

Palladium, silver, and platinum loading were measured before and after cyclic voltammetry using a calibrated X-ray fluorescence (XRF) method. All results from XRF measurements are reported in micrograms per sq. cm. The initial palladium loading was affected by whether or not the nickel mesh had been calcined before coating (Table 6). Calcining appears to reduce the loading of palladium.

TABLE 6
Precious Metal Loading Before Cyclic Voltammetry

| | Cal- | Hydrogen | Palladium | Silver | Ag % of | Platinum |
|---|---|---|---|---|---|---|
| Run # | cined | Bake | Loading | Loading | Base | Loading |
| 1 | no | no | 96 | 19 | 17% | 37 |
| 3 | no | yes | 83 | 50 | 38% | 34 |
| 6 | no | yes | 97 | 53 | 35% | 16 |
| 8 | no | yes | 89 | 63 | 41% | 17 |
| 2 | yes | no | 49 | 13 | 21% | 32 |
| 4 | yes | yes | 65 | 22 | 25% | 10 |
| 5 | yes | yes | 51 | 16 | 24% | 16 |
| 7 | yes | yes | 46 | 13 | 22% | 17 |

Cyclic voltammetry was conducted on all samples using the test settings detailed in Table 1. A portion of each sample was cut to dimensions of 2 cm by 2.5 cm. Each cut sample was spot welded onto a nickel lead frame and lowered into a temperature-controlled bath (84° C.) of 32% sodium hydroxide. The counter-electrode was nickel mesh, and the reference electrode used was a HydroFlex hydrogen reference electrode. Two connections were made to the working electrode, one at the top edge of the electrode for the working current, and another at the bottom edge to measure electrode potential, so a four-lead attachment method was used.

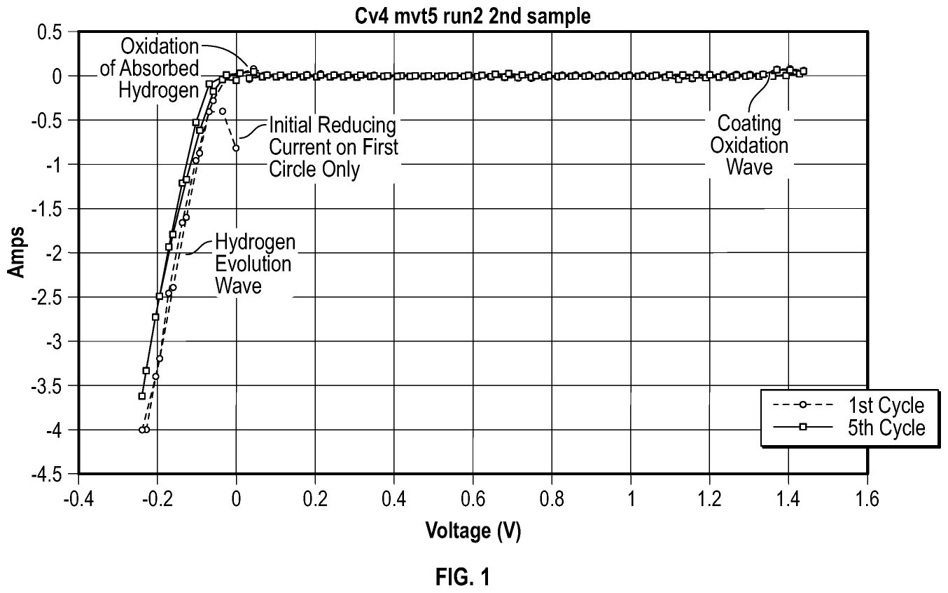

Many features of cathode performance are observed by cyclic voltammetry, and the data from each cycle can be viewed as current vs voltage. A typical plot of the first and fifth cycles of one cathode sample is shown in FIG. 1. The features of interest are shown in the call-outs of this diagram. The data from the hydrogen wave is on the left side of this plot, where hydrogen is evolved and negative (cathodic) current increases exponentially as a function of the negative voltage. Another feature of interest is the positive current observed during the positive scan after the potential exceeds 0 volts. This current captures the oxidation of hydrogen that remained adsorbed on the electrode after hydrogen evolution. On the positive end of each scan, a positive current indicates oxidation of components of the coating and oxygen evolution. On the first scan only, an initial reducing current is measured proportional to the coating components that can be reduced at the reference potential of a standard hydrogen electrode.

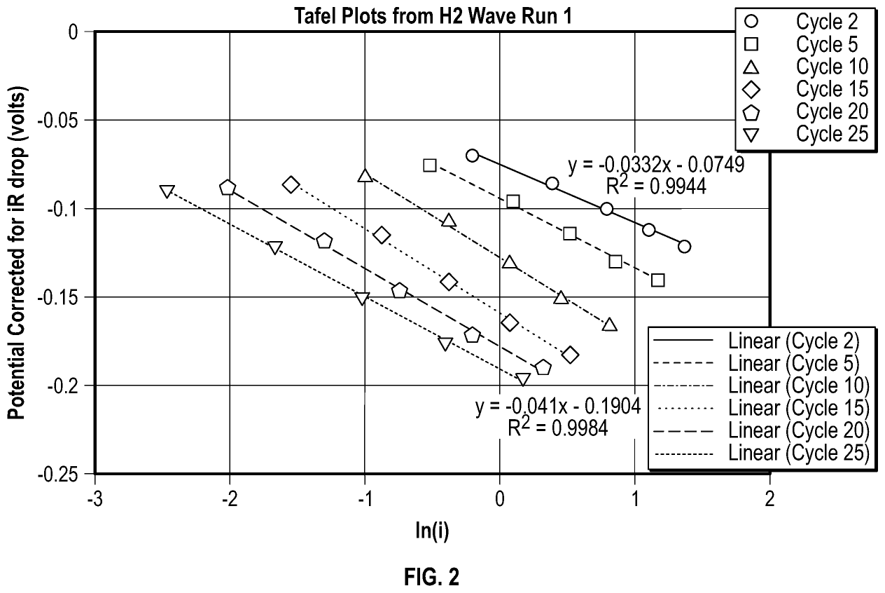

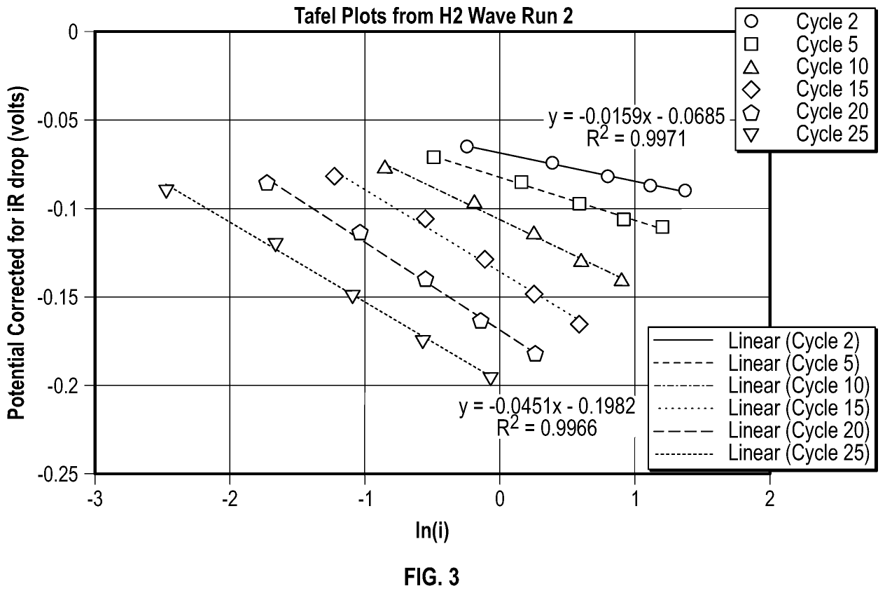

The hydrogen evolution wave was analyzed in greater detail by plotting potential relative to the SHE (standard hydrogen electrode) vs ln (current) for selected cycles. These results for runs 1 and 2, the samples that were not baked in hydrogen, are shown in FIGS. 2 and 3. These results are similar, and show that with more exposure to oxidation, the overvoltage increases. The non-calcined sample (run 1) appears to have a lower initial overvoltage and a lower Tafel slope.

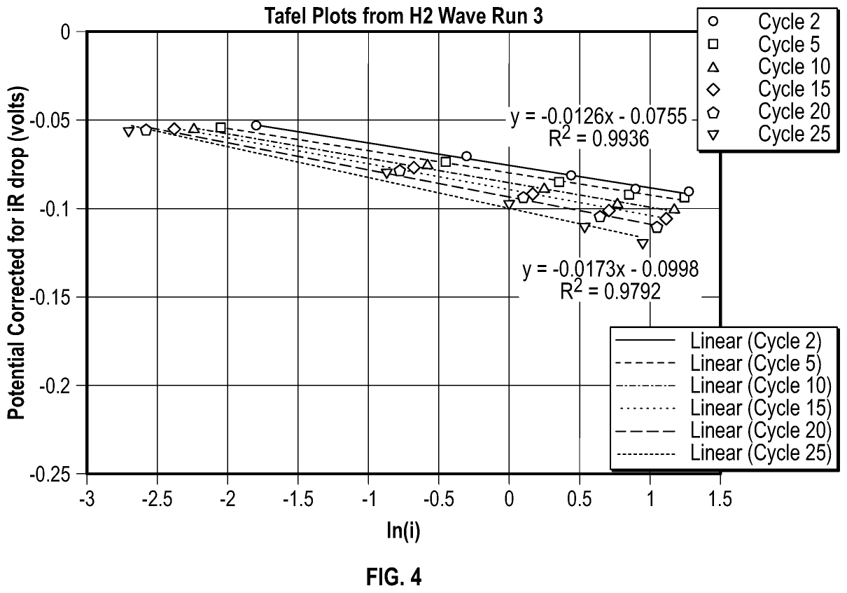

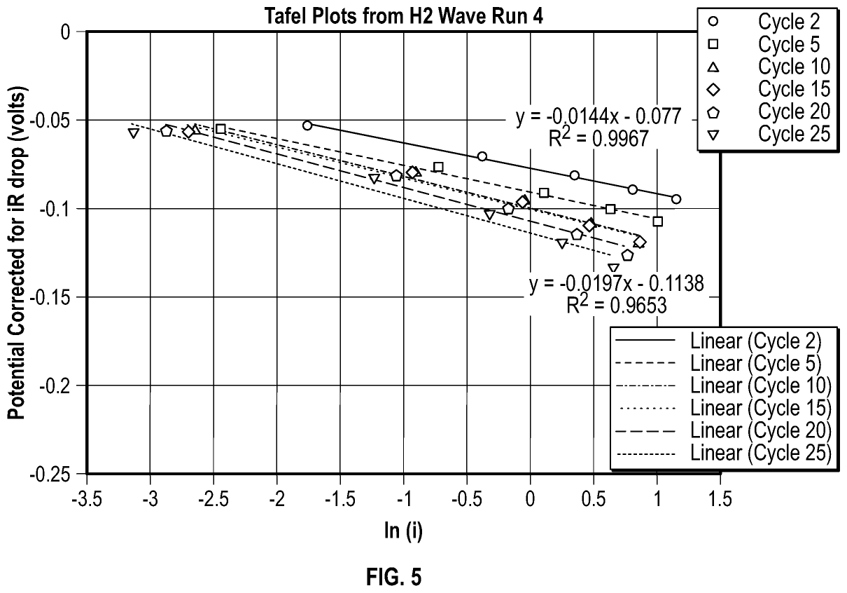

In contrast to the Tafel plots from runs 1 and 2, the slope of the voltage vs current in FIGS. 4 and 5 (runs 3 and 4, respectively) changes much less with subsequent cycles of oxidation and reduction, so that after exposure to 25 oxidation cycles, the hydrogen overvoltage of the electrode is only slightly increased.

The Tafel slope and overvoltage can be used to calculate an initial overvoltage that would be experienced in an electrolyzer. In the following table, the initial overvoltage and overvoltage after the 25th oxidation cycle are summarized for the 8 runs of this experiment shown below in Table 7.

TABLE 7
Summary of Results from Cyclic Voltammetry

| | | | | | | Hydrogen |
|---|---|---|---|---|---|---|
| | Baking | 1^{st} Cycle E | 25^{th} Cycle E | 1^{st} Cycle | 25^{th} Cycle | Discharge |
| Run # | Condition | @6 kA/m² | @6 kA/m² | Tafel Slope | Tafel Slope | Current |
| 1 | Air@500° C. | 0.100 | 0.239 | −0.033 | −0.044 | 0.142 |
| 2 | Air@500° C. | 0.133 | 0.285 | −0.056 | −0.053 | 0.080 |
| 3 | H₂@500° C. | 0.092 | 0.117 | −0.015 | −0.015 | 0.021 |
| 4 | H₂@500° C. | 0.084 | 0.134 | −0.013 | −0.019 | 0.023 |
| 5 | H₂@540° C. | 0.108 | 0.128 | −0.023 | −0.021 | 0.012 |
| 6 | H₂@540° C. | 0.111 | 0.146 | −0.028 | −0.027 | 0.023 |
| 7 | H₂@580° C. | 0.099 | 0.117 | −0.026 | −0.021 | 0.026 |
| 8 | H₂@580° C. | 0.126 | 0.220 | −0.039 | −0.049 | 0.027 |

The initial overvoltage for all runs are similar, but lowest for the cathodes treated in the hydrogen atmosphere furnace at 500° C. At higher treatment temperatures, overvoltage is slightly higher, possibly caused by some sintering of the palladium/silver deposits, causing some loss of surface area. After the 25th oxidation cycle however, hydrogen evolution potential is about 150 mV higher for the air-baked coatings, and only about 20 mV higher for coatings prepared with hydrogen baking. This data indicates the hydrogen baked coating accumulated less hydrogen than the air baked coatings.

Hydrogen discharge current is measured from the oxidation wave that appears just above zero volts with respect to SHE on the positive-going part of the first cycle. This current is proportional to the adsorbed hydrogen remaining on the electrode. The cathodes baked in air in runs 1 and 2 average more than 4 times more hydrogen discharge current than the cathodes baked in a hydrogen atmosphere. This data indicates that hydrogen baked coatings use less energy than the air baked coatings.

The loading of precious metals was measured on samples of cathode that had been analyzed by cyclic voltammetry and a loss of coating was observed in the Table 8.

TABLE 8
Precious Metal Remaining after Cyclic Voltammetry

| | Baking | Pd After | % Pd | Ag After | % Ag | Pt After | % Pt |
|---|---|---|---|---|---|---|---|
| Run # | Condition | CV | Remaining | CV | Remaining | CV | Remaining |
| 1 | Air@500° C. | 23 | 24% | 4 | 21% | 10 | 27% |
| 2 | Air@500° C. | 15 | 30% | 3 | 23% | 9 | 28% |
| 3 | H₂@500° C. | 72 | 87% | 32 | 64% | 17 | 50% |
| 4 | H₂@500° C. | 56 | 86% | 13 | 59% | 4 | 40% |
| 5 | H₂@540° C. | 46 | 90% | 10 | 63% | 9 | 56% |
| 6 | H₂@540° C. | 81 | 84% | 36 | 68% | 4 | 25% |
| 7 | H₂@580° C. | 40 | 87% | 6 | 46% | 13 | 48% |
| 8 | H₂@580° C. | 61 | 69% | 35 | 56% | 2 | 12% |

After cyclic voltammetry of the cathodes baked in air, oxidation causes a loss of more than 70% of palladium and 77% of silver, but after baking in hydrogen, palladium loss averaged just 16%, while silver loss averaged 40%. The loss of platinum averaged 64% for all runs and the variation, while large, was not statistically attributable to any variables in the experiment.

Superior cathode resistance to oxidation is demonstrated by cathodes treated in a hydrogen atmosphere furnace after applying a base layer of palladium and silver. This resistance to oxidation is exhibited by the improved stability of the Tafel slope, lower hydrogen overvoltage, and by dramatically lower losses of both palladium and silver from the coating following cyclic voltammetry.

A theory that explains the results seen in this experiment is that baking in the hydrogen atmosphere furnace reduced both palladium and silver to a metallic state and enabled diffusion of silver into the palladium, which resulted in a palladium silver alloy coating on the nickel mesh. The silver content of this alloy varied from 20% to 41% and appeared to substantially improve oxidation resistance. The cathodes prepared from mesh that were not calcined received heavier loadings of palladium and silver, but these cathodes did not show lower initial overvoltage or greater oxidation resistance. These results disprove the hypothesis that the effect of hydrogen atmosphere baking was due to differences in loading of palladium or silver alone.

While furnace temperatures of the hydrogen atmosphere furnace varied from 500 to 580° C. during the experiment, all conditions appeared to produce oxidation resistant palladium/silver coatings. The cathodes prepared at the lower temperature appear to have the lowest initial hydrogen overvoltage.

### Example 11: Caustic Surface Treatment

A 26-mesh nickel flyscreen was prepared by blasting with a 220-grit corundum and then rinsed with deionized water. The substrate was then immersed for 2 hours in 50% (w/w) sodium hydroxide solution heated to 130° C. The cleaning solution described successfully dissolved some embedded grit. By SEM-EDS analysis, the weight percent of aluminum oxide present on the surface of the substrate was reduced from 11% to 5% following the alkali metal hydroxide solution soak. This was followed by rinsing with deionized water and then calcining at 500° C. for 20 minutes in air.

1-95. (canceled)

96. A process for preparing an electrode comprising:
applying an internal coating on a core substrate and calcining the internal coating in one of a hydrogen, ammonia and inert atmosphere, the internal coating including one or more of palladium, silver, palladium-silver alloy and combinations thereof; and
applying an external coating on the core substrate, the external coating comprising at least one metal different than the internal coating.

97. The process of claim 96, wherein the electrode is a cathode.

98. The electrode of claim 96, wherein the core substrate comprises a metal selected from the group of nickel, iron, copper, and mixtures thereof.

99. The process of claim 96, further comprising roughening the core substrate prior to applying the internal coating.

100. The process of claim 99, further comprising cleaning the core substrate with a cleaning solution after roughening, the cleaning solution comprising at least one of a caustic base, a mineral acid, or an organic acid.

101. The process of claim 96, further comprising calcining the core substrate.

102. The process of claim 96, wherein the internal coating consists essentially of a palladium-silver alloy.

103. The process of claim 96, wherein applying the internal coating on the core substrate comprises applying the metal as a salt solution or by electroplating.

104. The process of claim 96, wherein the internal coating is calcined in the presence of pure hydrogen.

105. The process of claim 96, wherein the internal coating is applied via electroplating.

106. The process of claim 96, further comprising applying the internal coating as multiple layers.

107. The process of claim 96, wherein applying the external coating on the internal coating comprises applying the external coating as a solution and then calcining the external coating.

108. The process of claim 96, further comprising electrolyzing aqueous sodium chloride or potassium chloride in an electrolyzer comprising the electrode.

109. The process of claim 96, wherein the external coating comprises zirconium.

110. The process of claim 109, wherein the external coating further comprises one or both of ruthenium and platinum.

111. A process for preparing an electrode comprising:
applying an internal coating on a core substrate, wherein the internal coating is selected from the group consisting essentially of palladium, silver, palladium-silver alloy and combinations thereof; and
applying an external coating on the core substrate, the external coating comprising zirconium.

112. The process of claim 111, further comprising calcining the internal coating in one of a hydrogen, ammonia and inert atmosphere.

113. The process of claim 112, wherein applying the external coating on the internal coating comprises applying the external coating as a solution and then calcining the external coating.

114. The process of claim 111, wherein the internal coating is applied via electroplating.

115. A process for preparing an electrode comprising:
applying an internal coating on a core substrate via electroplating, the internal coating including one or more of palladium, silver, palladium-silver alloy and combinations thereof; and
applying an external coating on the core substrate, the external coating comprising at least one metal different than the internal coating.

116. The process of claim 115, wherein the external coating comprises zirconium.

117. The process of claim 116, wherein the external coating further comprises one or both of ruthenium and platinum.
